(19) United States
(12) Patent Application Publication
(10) Pub. No.: US 2026/0014576 A1
(43) Pub. Date: Jan. 15, 2026

(54) SIDE-PRESS SHOWER HEAD

(71) Applicant: Xiamen GSH Technology CO., LTD., Xiamen (CN)

(72) Inventors: Biao SHEN, Xiamen (CN); Shaochun LIN, Xiamen (CN)

(73) Assignee: Xiamen GSH Technology CO., LTD., Xiamen (CN)

(21) Appl. No.: 19/334,930

(22) Filed: Sep. 21, 2025

Related U.S. Application Data
(63) Continuation of application No. 18/338,537, filed on Jun. 21, 2023.

(51) Int. Cl. B05B 12/00; B05B 1/16; B05B 1/18

(52) U.S. Cl. CPC B05B 12/002; B05B 1/1636; B05B 1/18

(57) ABSTRACT

Disclosed is a side-press shower head, including a shower head body, a switching assembly, and a switching button. The shower head body includes a head portion and a handle portion. The switching assembly includes a switching member, a driving member, and a resetting member. The driving member is slidably mounted inside the head portion and is operatively linked to the switching member. The driving member moves in a direction parallel to the handle portion, and a driven inclined face is provided at the end of the driving member adjacent to the handle portion. The resetting member is disposed between the head portion and the driving member. The switching button is mounted on the side of the handle portion and is provided with a driving inclined face opposite the driven inclined face.

### TECHNICAL FIELD

The present disclosure relates to the technical field of kitchen and bathroom, and in particular, to a side-press shower head.

### BACKGROUND

Shower heads with a switching function on the market mostly utilize push-buttons or toggle switches positioned on the front for mode selection. During use, particularly when holding the shower head, if a user wishes to switch the water mode, they must adjust their grip to allow their thumb to press or push the switch in a more comfortable direction. After completing the switching action, they need to readjust their grip to ensure optimal water flow. Thus, the existing switching mechanism is inadequately designed and requires further improvement.

### SUMMARY

To solve the above technical problems, the present disclosure provides a shower structure that facilitates switching operations.

A side-press shower head includes a shower head body, a switching assembly, and a switching button.

The shower head body includes a head portion and a handle portion; and the head portion is provided therein with a water inlet channel and a plurality of water outlet channels.

The switching assembly includes a switching member, a driving member, and a resetting member. The switching member is mounted inside the head portion, and the water inlet channel is in communication with any water outlet channel through the switching member. The driving member is slidably mounted inside the head portion or the handle portion, and is operatively linked to the switching member to drive the switching member to perform a switching action. To facilitate the structural layout, the driving member moves in a direction parallel to the handle portion, and a driven inclined face is provided at the end of the driving member adjacent to the handle portion. The resetting member is disposed between the shower head body and the driving member and pushes the driving member to move toward the handle portion, thereby enabling the driving member to automatically reset after being released, facilitating the next switching action.

The switching button is mounted on the side of the connection between the head portion and the handle portion, and is provided with a driving inclined face opposite the driven inclined face; and when the switching button is pressed, the driving inclined face presses against the driven inclined face to drive the driving member to move.

In the present disclosure, the switching button is provided on the side of the shower head, and the shower head is provided therein with a switching assembly having an inclined face linked to the switching button. This design relocates the conventionally front-mounted driving switch to the side of the shower head, allowing users to switch water modes without altering their grip while holding the shower head. This offers significant ease of use, and ensures a natural and comfortable thumb posture during pressing and switching. Additionally, the driving assembly is designed to move parallel to the direction of the handle portion, taking advantage of the greater available space along the axial direction of the shower head. This not only facilitates structural layout but also increases flexibility in positioning the driving assembly.

Preferably, an angle between the driven inclined face and the handle potion is less than 45°, thereby enabling a small travel distance of the switching button to be converted into a large travel distance of the driving member. This helps reduce the protrusion size of the switching button around the periphery of the shower head, resulting in a more coordinated overall appearance of the shower head.

Preferably, the switching member includes a water distribution disc, a ratchet wheel, and a linkage disc. The water distribution disc is rotatably mounted inside the head portion of the shower head body, and is connected to and driven by the ratchet wheel. The linkage disc and the ratchet wheel are coaxially and rotatably mounted inside the head portion of the shower head body, and a linkage arm is provided on the periphery of the linkage disc. The side of the linkage arm facing the driving member is operatively linked to the driving member, and a distal end of the linkage arm extends to the periphery or end of the ratchet wheel to drive the ratchet wheel to perform a switching action. Thus, the driving member can drive the linkage disc, which in turn drives the ratchet wheel to rotate through the linkage arm of the linkage disc.

Preferably, unidirectional ratchet teeth are provided on the periphery of the ratchet wheel, and a driving tooth is provided on the end of the linkage arm. The linkage arm drives the ratchet wheel to rotate unidirectionally through the driving tooth and the unidirectional ratchet teeth. When the linkage disc and the linkage arm are reset, the end of the linkage arm moves relative to the periphery of the ratchet wheel. At this time, the driving tooth exits a ratchet tooth and enters the next ratchet tooth without causing reverse rotation of the ratchet wheel.

Preferably, an extending direction of the linkage arm is opposite a driving direction of the driving member. The driving tooth is a barb and is provided on the side of the end of the linkage arm facing the ratchet wheel. The linkage arm engages with the ratchet wheel through the driving tooth and drives the ratchet wheel to rotate unidirectionally through a pulling action. This driving method, even during switching action when the linkage arm is deformed, ensures the barb is unlikely to disengage from the ratchet teeth.

Preferably, an extending direction of the linkage arm is the same as a driving direction of the driving member. The driving tooth is provided at the end of the linkage arm. The linkage arm abuts against the ratchet teeth through the driving tooth and drives the ratchet wheel to rotate unidirectionally through a pushing action.

Preferably, a mounting groove is provided on the side of the driving member facing the switching member; a coupling head is provided on the end of the linkage arm facing the driving member, and the coupling head is inserted into the mounting groove; and the driving member drives the linkage disc to rotate through the mounting groove and the coupling head.

Preferably, the switching assembly further includes a limiting rod, one end of which is mounted inside the head portion of the shower head body, and the other end of which extends to abut against the ratchet teeth of the ratchet wheel.

Preferably, a linkage column is provided at the center of the water distribution disc, a linkage hole is provided at a central portion of the ratchet wheel, a clearance opening is provided at a central portion of the linkage disc, and a mounting cavity is provided in the shower head body. The water distribution disc is rotatably mounted inside the mounting cavity. The linkage column extends from the mounting cavity, passes through the clearance opening of the linkage disc and engages with the linkage hole of the ratchet wheel. The cross-sections of the linkage column and the linkage hole are identical and non-circular, such that the ratchet wheel can drive the water distribution disc to rotate.

Preferably, the driving member is strip-shaped, and a sliding groove for the driving member to slide is provided inside the head portion of the shower head body. The driving member is further provided with an elongated hole along a sliding direction, and a screw passes through the elongated hole and is threaded into the head portion of the shower head body. The resetting member is a spring, which is compressibly disposed between the end of the driving member and the head portion of the shower head body.

From the above description of the present disclosure, the present disclosure has the following beneficial effects.
1. In the present disclosure, the switching button is provided on the side of the shower head, and the shower head is provided therein with a switching assembly having an inclined face linked to the switching button. This design relocates the conventionally front-mounted driving switch to the side of the shower head, allowing users to switch water modes without altering their grip while holding the shower head. This offers significant ease of use, and ensures a natural and comfortable thumb posture during pressing and switching.
2. The driving assembly is designed to move in a direction parallel to the handle portion, taking advantage of the greater available space along the axial direction of the shower head. This not only facilitates structural layout but also increases flexibility in positioning the driving assembly.
3. An angle between the driven inclined face and the handle potion is less than 45°, thereby enabling a small travel distance of the switching button to be converted into a large travel distance of the driving member. This helps reduce the protrusion size of the switching button around the periphery of the shower head, resulting in a more coordinated overall appearance of the shower head.
4. In the switching member, the linkage arm of the linkage disc drives the ratchet wheel to rotate unidirectionally through a pulling action. This driving method, even during switching action when the linkage arm is deformed, ensures the barb is unlikely to disengage from the ratchet teeth.
5. The limiting rod is provided to effectively prevent the reverse rotation of the ratchet wheel and the water distribution disc.

### BRIEF DESCRIPTION OF DRAWINGS

The drawings described herein are used to provide further understanding of the present disclosure and constitute a part of the present disclosure. The exemplary embodiments of the present disclosure and their descriptions are used to explain the present disclosure and do not constitute improper limitations on the present disclosure.

FIG. 1 is a first axial side view of a side-press shower head;

FIG. 2 is a first exploded view of a side-mounted shower head;

FIG. 3 is a second exploded view of a side-mounted shower head;

FIG. 4 is a third exploded view of a side-mounted shower head; and

FIG. 5 is a fourth exploded view of a side-press shower head.

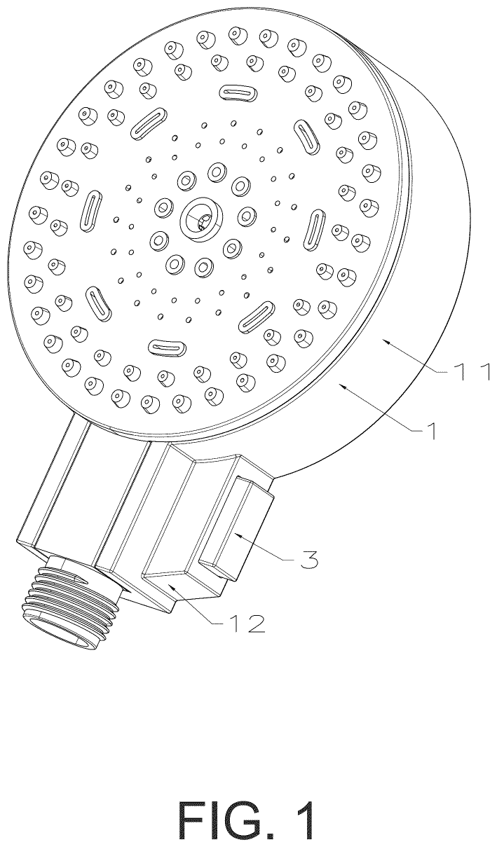

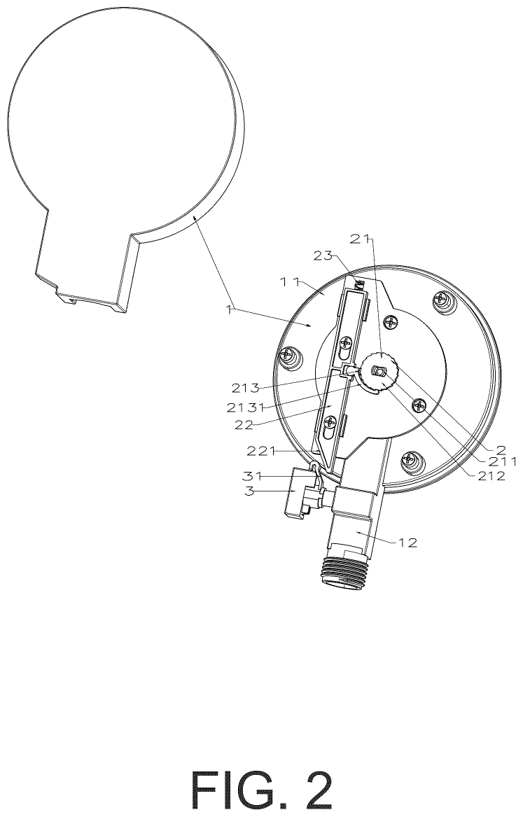

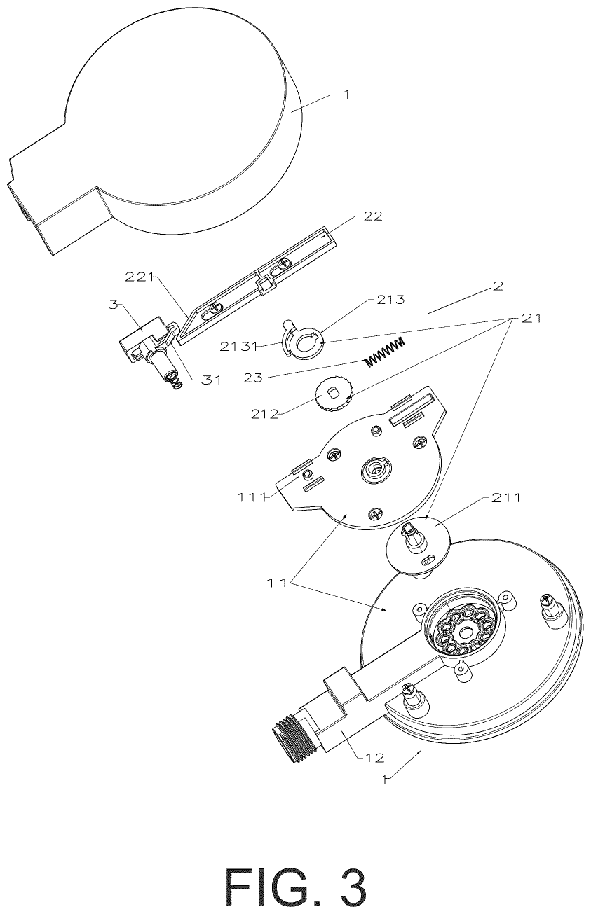

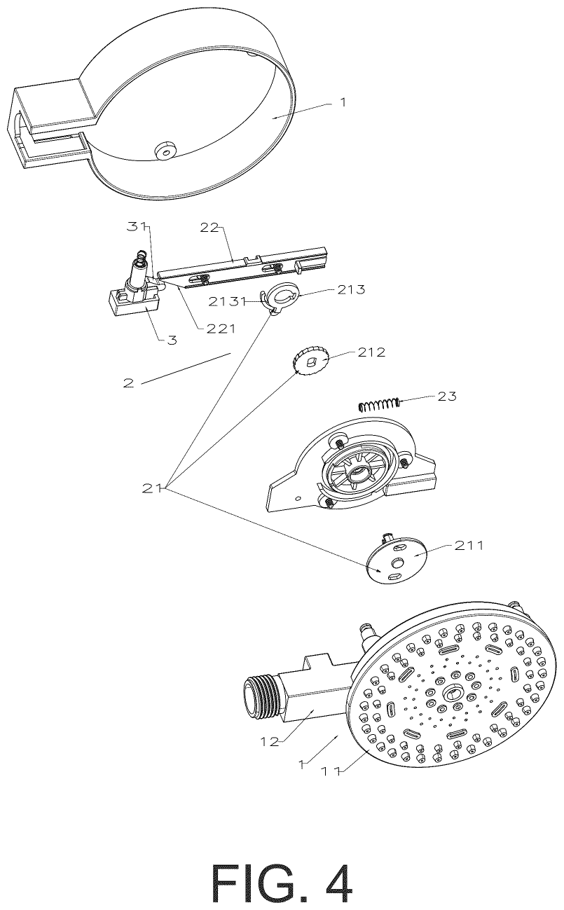

Reference signs in FIGS. 1 to 5: 1—Shower head body; 11—Head portion; 111—Sliding groove; 12—Handle portion; 2—Switching assembly; 21—Switching member; 211—Water distribution disc; 212—Ratchet wheel; 213—Linkage disc; 2131—Linkage arm; 22—Driving member; 221—Driven inclined face; 23—Resetting member; 3—Switching button; 31—Driving inclined face.

### DETAILED DESCRIPTION OF THE EMBODIMENTS

To make the technical problems to be solved, technical solutions and beneficial effects of the present disclosure clearer, the present disclosure is further described in detail below with reference to the accompanying drawings and embodiments. It should be understood that the embodiments described herein are only used to explain the present disclosure and are not intended to limit the present disclosure.

Referring to FIGS. 1 to 4, a side-press shower head includes a shower head body 1, a switching assembly 2, and a switching button 3.

The shower head body 1 includes a head portion 11 and a handle portion 12. The head portion 11 is provided therein with a water inlet channel and a plurality of water outlet channels.

The switching assembly 2 includes a switching member 21, a driving member 22, and a resetting member 23.

The switching member 21 is mounted inside the head portion 11, and the water inlet channel is in communication with any water outlet channel through the switching member 21.

In an embodiment, the switching member 21 includes a water distribution disc 211, a ratchet wheel 212, and a linkage disc 213. The water distribution disc 211 is rotatably mounted inside the head portion 11 of the shower head body 1, and is connected to and driven by the ratchet wheel 212. The linkage disc 213 and the ratchet wheel 212 are coaxially and rotatably mounted inside the head portion 11 of the shower head body 1, and a linkage arm 2131 is provided on the periphery of the linkage disc 213. The side of the linkage arm 2131 facing the driving member 22 is operatively linked to the driving member 22. A distal end of the linkage arm 2131 extends to the periphery or end of the ratchet wheel 212 to drive the ratchet wheel 212 to perform a switching action, such that the driving member 22 can drive the linkage disc 213 to rotate, and then drive the ratchet wheel 212 to rotate through the linkage arm 2131 of the linkage disc 213.

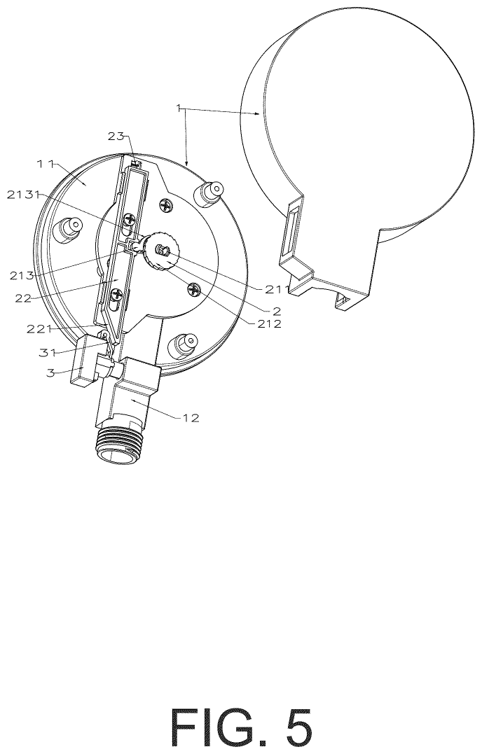

Specifically, unidirectional ratchet teeth are provided on the periphery of the ratchet wheel 212, and a driving tooth is provided on the end of the linkage arm 2131. The linkage arm 2131 drives the ratchet wheel 212 to rotate unidirectionally through the driving tooth and the unidirectional ratchet teeth. When the linkage disc 213 and the linkage arm 2131 are reset, the end of the linkage arm 2131 moves relative to the periphery of the ratchet wheel 212. At this time, the linkage arm 2131 is deformed, which allows the driving tooth to exit a ratchet tooth and enter the next ratchet tooth without causing reverse rotation of the ratchet wheel 212. In this embodiment, an extending direction of the linkage arm 2131 is opposite a driving direction of the driving member 22. The driving tooth is a barb, and is provided on the side of the end of the linkage arm 2131 facing the ratchet wheel 212. The linkage arm 2131 engages with the ratchet teeth through the driving tooth and drives the ratchet wheel 212 to rotate unidirectionally through a pulling action. This driving method, even during switching action when the linkage arm 2131 is deformed, ensures the barb is unlikely to disengage from the ratchet teeth. In another embodiment, as shown in FIG. 5, an extending direction of the linkage arm 2131 is the same as a driving direction of the driving member 22, the driving tooth is provided at the end of the linkage arm, and the linkage arm 2131 engages with the ratchet teeth through the driving tooth and drives the ratchet wheel 212 to rotate unidirectionally through a pushing action.

In addition, with respect to other specific structures and installation methods of the switching member 21, in an embodiment, a linkage column is provided at the center of the water distribution disc 211, a linkage hole is provided at a central portion of the ratchet wheel 212, a clearance opening is provided at a central portion of the linkage disc 213, and a mounting cavity is provided in the shower head body 1. The water distribution disc 211 is rotatably mounted inside the mounting cavity. The linkage column extends from the mounting cavity, passes through the clearance opening of the linkage disc 213 and engages with the linkage hole of the ratchet wheel 212. The cross-sections of the linkage column and the linkage hole are identical and non-circular, such that the ratchet wheel 212 can drive the water distribution disc 211 to rotate.

In another embodiment, the switching assembly 2 further includes a limiting rod, one end of which is mounted inside the head portion 11 of the shower head body 1, and the other end of which extends to abut against the ratchet teeth of the ratchet wheel 212.

The driving member 22 is slidably mounted inside the head portion 11 and is operatively linked to the switching member 21 to drive the switching member 21 to perform a switching action. Of course, in other embodiments, the driving member 22 may also be slidably mounted in the handle portion 12.

The driving member 22 moves in a direction parallel to the handle portion 12, and a driven inclined face 221 is provided at the end of the driving member 22 adjacent to the handle portion 12. The resetting member 23 is disposed between the head portion 11 and the driving member 22 and pushes the driving member 22 to move toward the handle portion 12, thereby enabling the driving member 22 to automatically reset after being released, facilitating the next switching action.

In an embodiment, the driving member 22 is strip shaped, and a sliding groove 111 for the driving member 22 to slide is provided in the head portion 11 of the shower head body 1. The driving member 22 is further provided with an elongated hole along a sliding direction, and is relatively fixed to the shower head body while remaining slidable by means of a screw that passes through the elongated hole and is threaded into the shower head portion 11. The resetting member 23 is a spring, which is compressibly disposed between the end of the driving member 22 and the shower head body 1. In addition, in another embodiment, a mounting groove is provided on the side of the driving member 22 facing the switching member 21, a coupling head is provided on the end of the linkage arm 2131 facing the driving member 22, and the coupling head is inserted into the mounting groove. The driving member 22 drives the linkage disc 213 to rotate through the mounting groove and the coupling head.

The switching button 3 is mounted on the side of the connection between the head portion 11 and the handle portion 12, and is provided with a driving inclined face 31 opposite the driven inclined face 221. When the button is pressed, the driving inclined face 31 presses against the driven inclined face 221 to drive the driving member 22 to move.

In an embodiment, an angle between the driven inclined face 221 and the handle portion 12 is less than 45°, thereby enabling a small travel distance of the switching button 3 to be converted into a large travel distance of the driving member 22. This helps reduce the protrusion size of the switching button 3 around the periphery of the shower head, resulting in a more coordinated overall appearance of the shower head.

During use, when the user presses the switching button 3, the switching button 3 is retracted. The driving inclined face 31 contacts and presses against the driven inclined face 221, causing the driving member 22 to retract into the head portion 11 of the shower head body 1. The retraction action subsequently drives the linkage disc 213 to rotate, which in turn drives the ratchet wheel 212 to rotate through the linkage arm 2131. Finally, the ratchet wheel 212 drives the water distribution disc 211 to rotate, thereby achieving the switching of water modes.

In the present disclosure, the switching button 3 is provided on the side of the shower head, and the shower head is provided therein with a switching assembly 3 having an inclined face linked to the switching button. This design relocates the conventionally front-mounted driving switch to the side of the shower head, allowing users to switch water modes without altering their grip while holding the shower head. This offers significant ease of use, and ensures a natural and comfortable thumb posture during pressing and switching.

The present disclosure is illustratively described above with reference to the accompanying drawings. It is obvious that the specific implementation of the present disclosure is not limited to the above embodiments. Any non-substantive modifications made using the methodological concepts and technical solutions of the present disclosure, or the direct application of the inventive concepts and technical solutions to other scenarios without modification, shall fall within the scope of protection of the present disclosure.

What is claimed is:

1. A side-press shower head, comprising a shower head body, a switching assembly, and a switching button, wherein:
the shower head body comprises a head portion and a handle portion; and the head portion is provided therein with a water inlet channel and a plurality of water outlet channels;
the switching assembly comprises a switching member, a driving member, and a resetting member; the switching member is mounted inside the head portion, and the water inlet channel is in communication with any water outlet channel through the switching member; the driving member is slidably mounted inside the head portion or the handle portion and is operatively linked to the switching member; the driving member moves in a direction parallel to the handle portion, and a driven inclined face is provided at the end of the driving member adjacent to the handle portion; and the resetting member is disposed between the shower head body and the driving member and pushes the driving member to move toward the handle portion; and
the switching button is mounted on the side of the connection between the head portion and the handle portion, and is provided with a driving inclined face opposite the driven inclined face; and when the switching button is pressed, the driving inclined face presses against the driven inclined face to drive the driving member to move.

2. The side-press shower head according to claim 1, wherein an angle between the driven inclined face and the handle portion is less than 45°.

3. The side-press shower head according to claim 1, wherein the switching member comprises a water distribution disc, a ratchet wheel, and a linkage disc; the water distribution disc is rotatably mounted inside the head portion of the shower head body, and is connected to and driven by the ratchet wheel; the linkage disc and the ratchet wheel are coaxially and rotatably mounted inside the head portion of the shower head body, and a linkage arm is provided on the periphery of the linkage disc; and the side of the linkage arm facing the driving member is operatively linked to the driving member, and a distal end of the linkage arm extends to the periphery or end of the ratchet wheel to drive the ratchet wheel to perform a switching action.

4. The side-press shower head according to claim 3, wherein unidirectional ratchet teeth are provided on the periphery of the ratchet wheel, a driving tooth is provided on the end of the linkage arm, and the linkage arm drives the ratchet wheel to rotate unidirectionally through the driving tooth and the unidirectional ratchet teeth.

5. The side-press shower head according to claim 4, wherein an extending direction of the linkage arm is opposite a driving direction of the driving member; the driving tooth is a barb and is provided on the side of the end of the linkage arm facing the ratchet wheel; and the linkage arm engages with the ratchet wheel through the driving tooth and drives the ratchet wheel to rotate unidirectionally through a pulling action.

6. The side-press shower head according to claim 4, wherein an extending direction of the linkage arm is the same as a driving direction of the driving member; the driving tooth is provided at the end of the linkage arm; and the linkage arm abuts against the ratchet teeth through the driving tooth and drives the ratchet wheel to rotate unidirectionally through a pushing action.

7. The side-press shower head according to claim 4, wherein a mounting groove is provided on the side of the driving member facing the switching member; a coupling head is provided on the end of the linkage arm facing the driving member, and the coupling head is inserted into the mounting groove; and the driving member drives the linkage disc to rotate through the mounting groove and the coupling head.

8. The side-press shower head according to claim 4, wherein the switching assembly further comprises a limiting rod, one end of which is mounted inside the head portion of the shower head body, and the other end of which extends to abut against the ratchet teeth of the ratchet wheel.

9. The side-press shower head according to claim 3, wherein a linkage column is provided at the center of the water distribution disc, a linkage hole is provided at a central portion of the ratchet wheel, a clearance opening is provided at a central portion of the linkage disc, and a mounting cavity is provided in the shower head body; the water distribution disc is rotatably mounted inside the mounting cavity; the linkage column extends from the mounting cavity, passes through the clearance opening of the linkage disc and engages with the linkage hole of the ratchet wheel; and the cross-sections of the linkage column and the linkage hole are identical and non-circular.

10. The side-press shower head according to claim 1, wherein the driving member is strip-shaped, and a sliding groove for the driving member to slide is provided inside the head portion of the shower head body; the driving member is further provided with an elongated hole along a sliding direction, and a screw passes through the elongated hole and is threaded into the head portion of the shower head body; and the resetting member is a spring, which is compressibly disposed between the end of the driving member and the head portion of the shower head body.
